(19) United States
(12) Patent Application Publication
(10) Pub. No.: US 2011/0220358 A1
(43) Pub. Date: Sep. 15, 2011

(54) ASSEMBLIES FOR THE PURIFICATION OF A RESERVOIR OR PROCESS FLUID

(75) Inventors: Kay Robinson, Cambridgeshire (GB); Nathan Lawrence, Cambridgeshire (GB); Andrew Meredith, Cambridge (GB)

(73) Assignee: Schlumberger Technology Corporation, Cambridge, MA (US)

(21) Appl. No.: 13/062,789

(22) PCT Filed: Aug. 26, 2009
(86) PCT No.: PCT/IB2009/006647

§ 371 Date: May 31, 2011

(30) Foreign Application Priority Data
Sep. 8, 2008 (GB) 0816347.9

(51) Int. Cl. E21B 31/00; C07H 99/00; C09K 8/80; B01D 15/04; E21B 19/00

(52) U.S. Cl. 166/301; 536/1.11; 507/209; 210/681; 210/688; 166/90.1

(57) ABSTRACT

A sugar-based assembly is provided for the removal of a component from a reservoir or process fluid. The sugar-based assembly comprises a sugar optionally bound to a support, and where the support is present, the sugar is bound directly to the support or via a linker group, and the use of the sugar-based assembly in methods of purification of reservoir or process fluids, including subterranean reservoir and process fluids.

### FIELD OF THE INVENTION

The present invention relates to sugar-based assemblies and their use in the removal of components from reservoir and process fluids, and particularly the clean-up of hydrocarbon and aqueous reservoirs.

### BACKGROUND

The recovery of reservoir and process fluids from subterranean locations may be complicated by the presence of components within the fluid that have the potential to harm the local aquatic ecosystem if released. In particular, the presence of heavy metals within some reservoir fluids has raised concern about the possible toxic effects of these fluids.

In some instances, recovered reservoir fluids and process fluids, or the downstream products of such fluids have been released into the environment. Where such fluids contain harmful or potential harmful components, there is a risk of ecological damage. Surplus reservoir fluids held in pools for future disposal have the potential to cause substantial harm to the surrounding environment if dangerous components are able to leach out from the fluid into the water table. It would be desirable to develop methods and apparatus for the removal of harmful and potentially harmful ions from reservoir fluids. Such a technique may be referred to as a “clean-up operation”.

Reservoir fluids are typically processed on a huge scale, and an individual hydrocarbon producing well may produce upwards of a thousand barrels a day. Process fluids may also be used on a large scale. Thus it would be desirable that a system to remove harmful components from reservoir and process fluids is reproducible, cost effective, efficient, simple, and amenable to large scale operation.

As described herein, the present inventors have discovered that sugar-based assemblies may be used advantageously to remove components from reservoir and process fluids. Furthermore, the inventors have also recognised that the removal of components from the reservoir or process fluid at an early stage, for example whilst the fluid remains below ground, minimises the potential for later environmental damage when the fluid is recovered, stored and processed.

### SUMMARY OF THE INVENTION

Accordingly, in a general aspect there is provided a sugar-based assembly for use in the removal of a component from a reservoir or process fluid. The sugar-based assembly may be used to remove one or more components from a reservoir or process fluid.

The present inventors have established that assemblies comprising sugar groups may be used to complex components such as heavy metals in reservoir or process fluids. Sugar-based assemblies are particularly advantageous for use in large scale separation processes owing to the general availability of various sugar groups and their relatively low cost. Furthermore, owing to the large number of sugar groups available, it is possible to choose those sugars having a greater selectively for one component over other species in the reservoir or process fluid. This advantage is further enhanced when it is considered that sugar groups may be derivatised to further improve selectivity and binding characteristics.

In a first aspect of the present invention there is provided a sugar-based assembly for use in the removal of a component from a reservoir or process fluid, the sugar-based assembly comprising a sugar immobilised in solid form. A sugar based assembly may comprise a support or carrier on which the sugar is immobilised. The sugar may be chemically bound to the support directly or via a linker group. The sugar which is used may be a polysaccharide, which may incorporate modifications to functional groups present on the polysaccharide chain and/or may be cross linked.

In a second aspect of the present invention there is provided the use of the sugar-based assembly of the first aspect of the invention in a method of removing a component from a reservoir or process fluid. The method comprises the steps of contacting the sugar-based assembly and a reservoir or process fluid containing a component to be removed, thereby to form a complex of the sugar-based assembly and that component. The complex is then separated from the reservoir or process fluid which is consequently depleted of the component. The sugar-based assembly with complexed component may subsequently be treated so as to release the component from the complex. The component may be subsequently isolated from the sugar-based assembly. The sugar-based assembly may be reused in the method above.

In a third aspect of the invention there is provide the use of a sugar-based assembly according to the first aspect of the invention as a ligand for a component in a reservoir or process fluid.

In a fourth aspect of the invention there is provided a filter for the removal of a component from a reservoir or process fluid, wherein the filter comprises a sugar-based assembly according to the first aspect of the invention.

In a fifth aspect of the invention there is provided the use of the filter of the invention in a method of removing a component from a reservoir or process fluid. The method may comprise the step of contacting a reservoir or process fluid comprising a component to be removed with the filter, thereby forming a complex of the sugar-based assembly of the filter and the component. The resulting reservoir or process fluid is consequently depleted of the component. The depleted reservoir or process fluid may then be separated from the filter.

In another aspect, the invention provides a downhole tool for use in the removal of a component from a downhole reservoir or process fluid, wherein the downhole tool comprises a sugar-based assembly of the invention. The tool is configured to operate downhole.

The downhole tool finds use in a method of removing a component from a downhole reservoir or process fluid. The method may comprise the step of deploying the downhole tool to a downhole location. The method may comprise the step of contacting the sugar-based assembly of the downhole tool with a reservoir or process fluid comprising a component which is to be removed, thereby to form a complex of the sugar-based assembly of the filter and the component and a reservoir or process fluid which is depleted of the component. The method may comprise a step of making the sugar-based assembly of the downhole tool available for contact with the downhole reservoir or process fluid.

In a further aspect of the invention there is provided a fracturing fluid comprising a sugar-based assembly of the invention. The fracturing fluid may comprise a proppant, and the sugar-based assembly may form part of the proppant. Also provided is a proppant carrying a sugar-based assembly of the invention. The sugar-based assembly may comprise a sugar bound to a support, wherein the sugar is bound directly to the support or via a linker group.

In another aspect of the invention there is provided the use of the fracturing fluid and proppant of the invention in a method of fracturing a reservoir formation.

Also provided is the use of a proppant of the invention in a method of removing a component from a reservoir fluid. The method may comprise the steps of delivering a proppant of the invention into a reservoir fracture thereby to provide a sugar-based assembly of the proppant at a reservoir fluid flow path, and contacting the sugar-based assembly of the proppant with a reservoir fluid, thereby to form a complex of the sugar-based assembly and the component, and a reservoir or process fluid which is depleted of the component. The method may comprise the preliminary steps of providing a fracturing fluid at a reservoir formation and fracturing the reservoir formation

The invention also provides a process for the preparation of a sugar-based assembly, the process comprising the steps of deploying a sugar to a subterranean location, and linking the sugar to geological formation at the subterranean location thereby to form a sugar-based assembly. The invention also provides the sugar-based assembly obtained or obtainable by this method.

The invention also extends to a reservoir fluid comprising (e.g. mixed with) a sugar-based assembly according to the first aspect of the invention. The invention also provides a process fluid comprising a sugar-based assembly according to the first aspect of the invention. In another aspect, there is provided a reservoir or process fluid that is obtained or obtainable by any method as described herein.

### BRIEF DESCRIPTION OF THE FIGURES

FIG. 1 charts the relationship between the lead uptake of an alginate bead of the invention (expressed as mg of Pb per dry bead) with respect to (a) the cross-linker used in the alginate bead-forming reaction; (b) the percentage equivalent of bead generator used in the alginate bead-forming reaction; (c) the amount of crosslinker used in the alginate bead-forming reaction; and (d) the temperature at which the alginate bead was prepared.

FIG. 2 charts the relationship between the lead uptake (expressed as mg of Pb per dry bead) of (a) an alginate bead of the invention with respect to maleic anhydride derivitisation, pH, temperature and the percentage equivalent of bead generator used in the alginate bead-forming reaction; and (b) an alginate bead of the invention with respect to tartaric acid derivitisation, pH, and the percentage equivalent of bead generator used in the alginate bead-forming reaction.

### DETAILED DESCRIPTION OF THE INVENTION

### Component

The component which is to be removed from a reservoir or process fluid by means of the sugar-based assembly of the invention may be something which is considered to be harmful or potentially harmful. The term “harmful” as used herein refers not only to the ability of a component to cause damage to a living organism, but also the ability of a component to cause damage to the apparatus used to extract and process the reservoir fluid, as well as other downstream apparatus. In one example, the component may be responsible for or catalyse the corrosion of metal piping and the like, leading to potential damage to apparatus in the vicinity of the corrosion. In particular, the component may be a scale forming species. The build up of scale on apparatus surfaces that contact the reservoir fluid may lead to significant operating problems.

Additionally or alternatively, the component may be a component that is capable of unwanted reaction with the reagents that are used to treat the obtained reservoir fluid or treat recovered process fluid. Unwanted reaction of the component with these reagents might for instance inactivate added reagents or result in the formation of harmful by-products.

Additionally or alternatively, the component may be a high value commodity which is worth recovering by means of the use of sugar-based assemblies described herein, which may comprise relatively inexpensive sugar.

It is envisaged that the component to be removed will initially be located in a subterranean location. The component is preferably an ion, notably a metal cation or a non-metal anion.

The ion may be a naked ion, that is an ion which is not associated with any ligands other than solvent ligands. Alternatively, the ion may itself be associated with one or more ligands other than solvent.

The sugar-based assembly may competitively displace one or more of these ligands (“substitution”) to form a complex as described herein. Alternatively the sugar-based assembly may form a complex with the ion without displacement of a ligand (“addition”). Preferably the ion is bound by the sugar of the sugar-based assembly. Additionally, the ion may also be bound by another group covalently attached to the sugar such as a linker group, where present.

Where the component to be removed is an ion associated with one or more ligands, the overall charge of the ion-ligand complex may be different to the charge of the ion itself. Thus, the ion-ligand complex may be a neutral complex, though the ion within the complex is itself charged.

A ligand may be an additive as described below, or may be a compound in the reservoir or process fluid, or a group on a surface of a geological formation.

The oxidation state of an ion within a reservoir or process fluid will typically be dependent on surrounding environmental conditions, e.g. oxidising or reducing environment, temperature and pH. The oxidation state may change as the fluid moves through the reservoir, through the well bore and to the surface. The change in oxidation state may be as a result of the ion coming into contact with a more oxidising environment, e.g. exposed to air.

A specific example of this concerns Cr (III) within a reservoir or process fluid. This ion may become oxidised to Cr(VI) under certain recovery conditions. The latter ion is particularly toxic, and is believed to be carcinogenic. Removal of this ion from a reservoir or process fluid is particularly desirable. Alternatively, the Cr(III) ion may be recovered from the fluid instead, prior to its conversion to toxic Cr(VI).

A component to be removed may be a (non-metal) boron ion, notably anionic boron, or may be a metal ion independently selected from the ions of a Group 2, Group 5, Group 6, Group 8, Group 9, Group 10, Group 11, or Group 12 metal, and may be an ion of a heavy metal

More specifically, an ion may be independently selected from the ions of the non-metal B and the metals Cu, Cr, Fe, Co, Ni, Ba, Ca, Sr, Mo, W, Zn, Cd, Hg, Mg, Pb, Pd, Pt, and V. A metal ion may be independently selected from Cu (II), Cr (III), Cr (VI), Fe (III), Co (II), Co (III), Co (IV), Ni (II), Ba (II), Ca (II), Sr (II), Mo (VI), W (VI), Zn (II), Cd (II), Hg (II), and Pb (II).

The sugar-based assembly is preferably used to recover components that are associated with scale formation or wastewater contamination, and toxic ions such as lead and mercury. These are described below.

A scaling ion may be an ion that is present in a scale selected from calcium carbonate (calcite), magnesium silicate, amorphous silica, calcium sulfate dihydrate (gypsum), strontium sulfate (celestite), and iron sulfide and iron carbonate.

The scaling ion may be selected from Ca, Mg, Ba, Sr, Ra or Fe.

A wastewater ion contaminant may be an ion that is present in a body of water at a concentration above the maximum that is permitted for the safe or legal disposal of the water into the environment, for example, into the sewer or for release into storage ponds. The sugar-based assembly of the invention may be used to reduce the level of the ion to a level at which it is permitted to release the water into the environment.

The wastewater ion contaminant may be selected from As, Ba, Cd, Cr, Cu, Fe, Pb, Mn, Hg, Mo, Ni, Se, Hg, Sn, or Zn.

In one particularly preferred embodiment, the component is an Hg ion. The ion may be Hg (II). Hg and its ions are recognised as having the potential to seriously damage the surfaces of reservoir and process fluid processing facilities. Particularly, Hg is known to damage Al-based heat exchangers. Thus, It is particularly desirous to reduce Hg levels in a reservoir or process fluid.

In another particularly preferred embodiment, the component is a Pb ion. The ion may be Pb (II). Pb and its ions are recognised as being harmful to the environment and are particularly undesirable as contaminants of an aquifer fluid.

### Sugar-Based Assembly

The present invention provides a sugar-based assembly for use in the removal of a component from a reservoir or process fluid, notably in the clean-up of reservoir fluids. Generally, a sugar-based assembly of the invention comprises one or more types of sugar immobilised in solid form. The sugar may be immobilised in solid particulate form, notably macromolecules formed into beads or other particles, and which may possibly be porous. Macromolecules may be joined by cross linking in such particles.

Another possibility is that the sugar-based assembly comprises a sugar attached to a support. The sugar may be attached directly i.e. through a covalent bond. The sugar may be held to the support by other binding interactions, including ionic interactions or hydrogen bonding interactions, amongst others. The sugar may be a coating over the surface of the support.

In preferred embodiments the sugar-based assembly comprises one or more types of sugar bound to a support. Each sugar may be independently bound to the support indirectly, i.e. via a linker group or directly, i.e. through a covalent bond.

The sugar-based assembly should have little or no solubility in the reservoir or process fluid both before and after complexing with the component which it is intended to remove. Thus, the sugar-based assembly and/or the complex may be separated from the reservoir or process fluid by simple filtration.

Where a sugar-based assembly is intended to be selective for one component over another, the sugar-based assembly has a greater absorption capacity for that one component over the other. The absorption capacity may be expressed as the amount of component held in complex in relation to the amount of sugar, or sugar-based assembly.

A sugar-based assembly may be selective for a first component over a second component where the absorption capacity of the assembly for the first component is 2 or more, 3 or more, 5 or more, 10 or more 20 or more, 50 or more, 100 times or more, or 1,000 times or more greater than the absorption capacity of the assembly for the second component.

The selectivity of different sugar-based assemblies for the same component may be expressed in a similar manner.

Alternatively, selectivity may be expressed by reference to stability constants for the resultant complexes.

### Support

In some embodiments of the invention the sugar-based assembly comprises a support which is likely to be solid and is not itself sugar. The support of the sugar-based assembly comprises a modifiable surface. The modifiable surface allows attachment of the sugar or linker. The support may be in any form that is suitable for use in a subterranean environment.

General techniques for the derivitisation of supports and the attachment of affinity ligands are well known in the art.

The sugar may be attached directly i.e. through a covalent bond. The sugar may be bound to the support by other binding interactions, including ionic interactions or hydrogen bonding interactions, amongst others.

In some embodiments, the support may be coated with sugar as described herein. This is preferred where the support is a particle. The coating should be of sufficient strength to cope with the mechanical and physical stresses placed upon it in use in a subterranean environment.

A support may be a surface of a geological formation such as a reservoir formation surface. The formation may be located around a borehole. Such a formation may be consolidated or unconsolidated and may be clastic rock such as sandstone or carbonate rock such as limestone.

The formation may comprise feldspar, mica, calcite, quartz, feldspar, kaolinite, chlorite, illite or smectite (montmorillonite).

A sugar-based assembly comprising a subterranean formation surface support may be used to complex components downhole. Such use retains the component downhole and therefore avoids bringing harmful components to the surface, reducing the potential for environmental damage and reducing the need for further surface processing steps to remove such components.

The support for use in the invention is not limited to a formation surface. In other embodiments, the support may be a film, a particle, or a mesh. The support may comprise a glass, a polymer, a ceramic, a carbon, a metal or metal alloy surface, or a combination thereof. The support is preferably unreactive to reservoir or process fluid.

The support may be a lining or casing on the well bore. The sugar may be attached to a surface of the lining or casing that contacts or will contact a reservoir or process fluid as the fluid moves within the reservoir or towards the surface.

Where the support is not formation, the sugar-based assembly may nevertheless be attached to a formation surface in use. The sugar-based assembly is preferably attached to the formation through the support.

In one embodiment, the support may itself be or comprise a second sugar (referred to herein as “the support sugar”) which differs from the sugar which binds the component to be removed. The support sugar may be selected based on its mechanical and physical attributes, whilst the first sugar maybe selected based on its binding affinity and selectivity.

In other embodiments of the invention, the sugar-based assembly does not include a support as described herein. Instead, the sugar of the sugar-based assembly is formulated in a solid form suitable for deployment into a subterranean location. The sugar may be formulated as a particle. The sugar may be a crystalline particle. This particle may be used in the same manner as the sugar-based assemblies having a non-sugar support as described herein. The sugar is preferably a polysaccharide.

### Sugar

The sugar of the sugar-based assembly forms a complex with the component to be removed from the reservoir or process fluid. This complex is then separated from the reservoir or process fluid, which is thereby depleted of that component.

The sugar selected will be chosen based on cost considerations, ease of manufacture, storage stability and on binding affinity and selectivity for the component to be removed. A sugar may be a monosaccharide, disaccharide, oligosaccharide (typically 3 to 10 saccharide units) or polysaccharide (typically 11 or more saccharide units). Where there are two or more saccharide units in the sugar, a unit may be the same or different to its neighbour or neighbours. A saccharide unit may be connected to another saccharide unit through a glycosidic bond. The bond may be α- or β-.

Where the sugar-based assembly is constituted by sugar in particle form, it is preferred that the sugar is a polysaccharide, possibly with modifications to functional groups. It may be immobilised onto a particulate support.

One or more hydroxyl groups in the sugar may be deprotonated. One or more hydroxyl groups on each saccharide unit may be deprotonated.

Where the sugar is a polysaccharide, that saccharide may be cross-linked. Cross-linking may improve the degradation resistance of the sugar. Cross-linking is especially preferred where the sugar-based assembly is a sugar particle.

A sugar-based assembly may comprise one or more different sugars. Where a support is present, each sugar is independently bound to the support, either indirectly through a linker group or directly by a covalent bond.

In one embodiment, there is only one type of sugar in the sugar-based assembly.

Preferably, the sugar is a sugar that occurs naturally. A sugar that is obtained from a natural source may be preferred as the use of a natural product is frequently considered more environmentally acceptable compared to sugars that are prepared by industrial processes or laboratory organic synthesis. Sugars that are derived from commercial agricultural processes may be preferred owing to their availability and relative cost.

The sugars may also be prepared by biotechnological processes.

### Saccharide Unit

A saccharide unit is or is derived from a carbohydrate group. These units may be linked to form disaccharides, oligosaccharides and polysaccharides. The unit may be a simple carbohydrate, or it may be a derivative or a variant of a carbohydrate.

A carbohydrate group, as referred to herein, refers to a basic, unmodified carbohydrate, such as glucose, fructose and galactose.

A variant of a carbohydrate is a carbohydrate where one or more hydroxyl groups of a carbohydrate group is formally replaced with another group. Each replacement group may be independently selected from an amino group, a carboxylic acid, an alkyl group, an aryl group such as a nucleobase, a sulfate group, a thiol group and a phosphate group, amongst others. A variant also includes deoxysugars, where a hydroxyl group is formally replaced with hydrogen, for example deoxyribose.

In one embodiment, the anomeric hydroxyl group may be replaced with another group. Many sugars comprising variant carbohydrate groups are commercially available. Others may be readily prepared using techniques familiar to one of skill in the art.

A derivative of a carbohydrate is a carbohydrate where one or more hydroxyl groups of a carbohydrate group is substituted with a substituent. Derivatives also include those groups where the hydroxyl groups are protected as acetals, esters and ethers. Preferably the substituent comprises a group selected from: an amino group, a carboxylic acid, an alkyl group, an aryl group such as a nucleobase, a sulfate group, a thiol group and a phosphate group, amongst others. Many carbohydrate protecting groups are known in the art. Reference may be made to Green and Wuts, Protective Groups in Organic Synthesis (3rd Edition, 1999), which is incorporated herein in its entirety, for examples.

The inventors have found that the absorption capacity of a sugar-based assembly for a metal ion may be increased by increasing the amount of certain functional groups in the sugar. The amount of the functional group may be increased by derivatising a sugar, or by selecting a related variant or derivative having an increased amount of that functional group, or both.

In particular, the inventors have found that increasing the amount of carboxylic acid moieties in a sugar increases the absorption capacity of an alginate-based assembly for lead ions. In other embodiments, the amount of amine functional groups may be increased for the purposes of increasing absorption capacity.

Such derivatives or variants may comprise, where appropriate, on average, 1 or more, 1.25 or more, 1.5 or more, 1.75 or more, or 2 or more, 2.5 or more, or 3 or more of the certain functional group per saccharide unit. Thus, in one embodiment, a sugar may comprise, on average, 1 or more carboxylic acid groups per saccharide unit.

Where a variant has a replacement group or a derivative has a substituent group, the group may form part of the connection to the support, either directly as a covalent bond or as a bond to a linker group. In other embodiments, the substituent group or the replacement group does not form part of the connection to the support, or the connection to the linker group.

Where appropriate, the saccharide functional groups may be protonated or deprotonated. Where a saccharide contains a carboxyl, thiol or hydroxyl group, this group may be deprotonated. Where a saccharide contains an amine group, this group may be protonated.

A monosaccharide may be or may be derived from glucose, fructose, galactose, xylose and ribose, or variants thereof. A variant of a carbohydrate may be an amino sugar such as glucosamine. A disaccharide, oligosaccharide or polysaccharide may comprise one or more of any of these saccharides.

Many sugars comprising variant carbohydrate units are commercially available. Others may be readily prepared using techniques familiar to one of skill in the art.

Additionally or alternatively, a saccharide unit may be a derivative of a variant of a carbohydrate group. For example, a hydroxyl group of a glucosamine saccharide unit may be substituted with a substituent.

In one embodiment, a saccharide unit in a sugar may be independently a carbohydrate, a carbohydrate derivative, a carbohydrate variant, or a carbohydrate derivative of a variant.

Each saccharide unit may be independently derived from a four carbon carbohydrate, a five carbon carbohydrate or a six carbon carbohydrate, where the number of carbon atoms is the number of atoms in the main chain.

Each saccharide unit may be independently in an aldose or ketose form, and independently in a D- or L-form. Each saccharide unit may be independently in the α- or β-form. Where there are two or more saccharide units in a sugar, the units may be α- or β-linked or a mixture of both.

Each saccharide unit may be independently selected from furanose and pyranose forms, where appropriate.

The saccharide unit may be or may be derived from a branched carbohydrate. For example, the saccharide unit may be apiose.

A saccharide unit derived from a four carbon carbohydrate may be independently selected from erythrose and threose, and variants and derivatives thereof. The D-forms are most preferred.

A saccharide unit derived from a five carbon carbohydrate may be independently selected from ribose, arabinose, xylose, lyxose, ribulose and xylose, and variants and derivatives thereof. The D-forms are most preferred. Preferably, the saccharide unit is selected from ribose and xylose, and variants and derivatives thereof. A preferred variant of ribose is deoxyribose.

A saccharide unit derived from a six carbon carbohydrate may be independently selected from allose, altrose, glucose, mannose, gulose, idose, galactose, talose and fructose, and variants and derivatives thereof. The D-forms of these carbohydrates as well as L-galactose are most preferred. Preferably the saccharide unit is selected from glucose, mannose, galactose and fructose, and variants and derivatives thereof. A preferred variant of mannose is rhamnose. A preferred variant of glucose is glucosamine. The variants daunosamine and N-acetyl-galactosamine may also be selected as a saccharide unit.

A saccharide unit may be cyclic or acylic form. The cyclic form of the saccharide unit is most preferred. However, some units in a polysaccharide may be “ring-opened”. Such units are obtainable by treatment of the polysaccharide with an oxidant, such as a periodate.

In one embodiment, the sugar is selected from a monosaccharide, a disaccharide, and a trisaccharide. It is preferred that the sugar is a monosaccharide.

In other embodiments, the sugar is a polysaccharide. The polysaccharide may have 11 or more, 50 or more, 100 or more, 500 or more, or 1,000 or more saccharide units. The number of units may be an average.

In some embodiments, the sugar is chosen based on the selectivity of that sugar to bind one component over another component. The use of such a sugar may provide a sugar-based assembly having a greater absorption capacity for that one component over the other component.

In some embodiments, the sugar is chosen based on the selectivity of different saccharide units of that sugar to selectivity and independently bind different components. Thus one type of sugar may be used to complex two or more components based on the differing selectivities of the saccharide units within the sugar. Additionally or alternatively, different sugar-based assemblies may be used to achieve the same effect. However, this is less preferred, as it requires the construction and use of several different sugar-based assembly types. In another embodiment, the sugar-based assembly may comprise more than one type of sugar to achieve the same effect.

Such selectively may also arise from the particular conditions of the reservoir or process fluid and the surrounding environment, including temperature and pH. These conditions may be altered by a well operator to maximise complexation of the component to be removed.

A saccharide or a sugar-based assembly may contain an analytical label for detection and analysis of the sugar-based assembly. This label may be detectable by IR, UV or NMR spectroscopy. The label may be fluorescent or radioactive. Such labels may be of use in the detection and quantification of sugar-based assemblies in a reservoir or process fluid.

### Complex

The sugar of the sugar-based assembly forms a complex with the component to be removed from the reservoir or process fluid. Such a complex may be generated by the chelation of one or more hydroxyl groups of the sugar with the component. One or more hydroxyl groups involved in the chelation of the component in the complex may be deprotonated. Typically the complex is formed with a saccharide unit binding one or two components. In some embodiments, a component is bound in a complex with two saccharide units. These units may be the same or different. The saccharide units may be part of the same sugar, or may be part of different sugars on the support. The saccharide units may be on different sugar-based assemblies, although this is less preferred.

The sugar-based assembly may be referred to as a ligand in the complex. The sugar-based assembly can be described as sequestering the component to be removed from the reservoir or process fluid.

Other functional groups may be involved in the complex, such as carboxylic acid groups and amine groups and other hydroxyl groups. Such groups may be located on the sugar itself, on the linker, or may be located on an additive. In one embodiment, one, or more where appropriate, saccharide unit in a sugar may have a functional group selected from an amino group, a carboxylic acid group, a sulfate group, a thiol group and a phosphate group. These groups may function as anchoring groups that promote the coordination and/or the deprotonation of the hydroxyl groups of the saccharide.

These other groups may be used in addition to the hydroxyl groups mentioned above, or in place of the hydroxyl groups.

Additionally, other components in the reservoir or process fluid may participate as ligands in the complex.

Where the sugar comprises a substituent group, the substituent group may be involved in the complex. In certain embodiments this substituent group ligand does not form part of the connection to the support or part of the connection to a linker.

In another embodiment, the linker group may comprise a functional group selected from an amino group, a carboxylic acid group, a sulfate group, a thiol group and a phosphate group. Such groups may also function as anchoring groups.

Preferably a saccharide unit for use in binding a component comprises two or three hydroxyl groups, each of which is a chelating group in the complex. In one embodiment, the saccharide unit for use in binding a component comprises an amino group or carboxylic acid group, and the amino group or carboxylic acid group is a chelating group in the complex. These groups may replace one or more of the two or three hydroxyl groups.

The steric arrangement of the hydroxyl groups on the saccharide unit may be selected to maximise component binding ability. The arrangement of the hydroxyl groups may also be selected to maximise binding selectivity.

For a pyranose saccharide ring, two or three hydroxyl groups may be arranged with respect to one another in an arrangement selected from: 1,3,5-ax-ax-ax triol, 1,2,3-ax-eq-ax triol, cis-diol and trans-diol. In one embodiment the sugar comprises one or more pyranose saccharide units having at least three hydroxy groups in a 1,3,5-ax-ax-ax triol or 1,2,3-ax-eq-ax triol arrangement.

For a furanose saccharide ring, two hydroxyl groups may be arranged with respect to one another in an arrangement selected from cis-cis triol and cis-diol. In one embodiment the sugar comprises one or more furanose saccharide units having three hydroxy groups in a cis-cis triol arrangement.

The hydroxyl groups in the arrangements described above may be substituted as described for the saccharide derivatives for use in the invention, or replaced with a replacement group, as described above for the variants for use in the invention. The preferred replacement groups are amino groups and carboxylic acid groups.

### Linker Group

In some embodiments, the sugar of the sugar-based assembly may be bound to a support. The sugar may be bound to the support indirectly via a linker or directly via a covalent bond. Preferably the connection between the sugar and the support is provided by a linker group.

Where the connection is provided by a covalent bond, the bond may be between any atom or group on the sugar, and the support. The bond may be to the anomeric carbon atom on the sugar. This may be referred to as a glycoside bond. Alternatively, the bond may be between a hydroxyl group on the sugar and the support.

Where the connection is provided by a linker group, the linker group may be attached to any atom or group on the sugar. The linker may be attached to the anomeric carbon atom on the sugar. This may be referred to as a glycoside bond. Alternatively, the linker may be attached to a hydroxyl group on the sugar.

The linker group may be any group that forms a structural link between the sugar and the support. The linker may be selected based on the ease by which it may be attached to the sugar or the support or both.

The linker may comprise one or more saccharide units. The saccharide unit may not be covalently bonded to a sugar of the sugar-based assembly. Where there are two or more saccharide units in the linker, they may be bound through a glycoside covalent bond or they may be spaced apart. In other embodiments, the linker does not comprise a saccharide unit.

In certain embodiments, the linker group may participate with the sugar to form a complex with the component. The linker group, therefore, may function as a ligand in the complex.

The linker group may contain an analytical label for detection and analysis of the sugar-based assembly. This label may be detectable by IR, UV or NMR spectroscopy. The label may be fluorescent or radioactive. Such labels may be of use in the detection and quantification of sugar-based assemblies in reservoir or process fluid.

### Preparation of Sugar-Based Assemblies

In one embodiment, the sugar-based assembly of the invention may be one or more sugars. The sugars may be in the form of a particle. Sugar particles may be prepared by crystallisation, or more generally precipitation, of the sugar, typically a polysaccharide, which may be crosslinked if required.

The sugar-based assemblies may comprise a sugar attached to a support either directly or indirectly thorough a linker. Such assemblies may be prepared using standard techniques for the coupling of molecules to supports. The reactivity and derivitisation of sugar groups is well documented in the art. Such techniques may be used in combination with the techniques known in the art for the derivitisation of supports with small and large organic molecules, to prepare the sugar-based assemblies of and for use in the present invention.

In one embodiment, the support of the sugar-based assembly is geological formation. The formation is preferably formation within the reservoir and is preferably formation located along a reservoir fluid flow path in the reservoir.

The present invention provides a process for the preparation of a sugar-based assembly, the process comprising the steps of deploying a sugar to a downhole location, and linking the sugar to a formation surface thereby to form a sugar-based assembly. The sugar may be deployed to the downhole location from the surface. The sugar may be contained in a downhole tool or may be carried in a drilling fluid or a fracturing fluid, or similar.

The process may comprise the additional step of derivatising the formation with a linker group. The linker may be deployed to the downhole location from the surface. Preferably, the linker group is attached to a silicate group on the surface of the formation. Techniques for the derivatisation of silicate surfaces are known in the art. The method may comprise the step of connecting a sugar to a linker-functionalised surface thereby to form a sugar-based assembly of the invention. Alternatively, the method may comprise the step of connecting a linker-functionalised sugar to a formation surface. The linker-functionalised sugar may be prepared at the surface and delivered to the downhole location. A coupling reagent may also be delivered to a downhole location either with, before or subsequent to the delivery of the sugar, linker group or linker-functionalised sugar to the downhole location.

In one embodiment, the sugar-based assembly is prepared substantially as described herein with reference to the examples.

### Reservoir or Process Fluid

The sugar-based assemblies of the present invention are particularly envisaged for use in the removal of components from reservoir fluids in an oilfield. The assemblies may also find use in the cleanup of waterbodies, which may be aquifers. These aquifers may or may not be associated with an oilfield. The sugar-based assemblies may also be suitable for use in the removal of components from process fluids, such as drilling muds and fracturing fluids.

In a general aspect, the present invention provides a sugar-based assembly for use in the removal of a component from any fluid that is located at a subterranean location or is taken from a subterranean location. This fluid may be a reservoir fluid or a process fluid. It is preferred that the subterranean location is a reservoir. The subterranean location may also be a wellbore. In preferred embodiments, the reservoir fluid or process fluid is located at a subterranean location.

A reservoir fluid is therefore a fluid that is located in or is taken from a subterranean reservoir. Preferably, the reservoir fluid is located in or is taken from a subterranean reservoir located at least 10 m, at least 50 m, at least 100 m, at least 1,000 m or at least 5,000 m vertical depth below the surface. The surface may be the sea bed.

A reservoir may comprise a hydrocarbon-bearing portion and/or a water-bearing portion. A hydrocarbon reservoir may also be known as a petroleum reservoir. An aquifer is a water-bearing formation. Where reference is made to a reservoir, such reference is to a subterranean formation having sufficient porosity and permeability to store and/or transmit a fluid.

A reservoir fluid may comprise hydrocarbons, water or both. The reservoir fluid may be a predominantly organic phase, or a predominantly aqueous phase, or a mixture of phases.

The reservoir fluid may a colloid. The fluid may be an emulsion, a foam, a liquid aerosol, a gel, a gas, a solid foam or a solid aerosol. Where, the reservoir fluid is a colloid, it is preferably an emulsion.

In an alternative embodiment, the reservoir fluid may be a fluid that has been taken from a subterranean location. The reservoir fluid may be taken to a surface location or another subterranean location. The other subterranean location may be a wellbore, and may include the openhole or uncased portion of the well.

In the methods described herein, the reservoir fluid may be present at a subterranean location (a subterranean reservoir fluid) or present at the surface (a surface reservoir fluid). In the latter case, the fluid is taken from a subterranean location and brought to the surface.

Where the reservoir fluid comprises water, the aqueous phase may comprise hydrocarbons, brines and heavy metals as other components. The fluid may comprise total organic carbon, total petroleum hydrocarbons, and As, Ba, Cd, Cr, Pb, Hg, Se and Ag ions, amongst others.

A reservoir or process fluid may be neutral, acidic or basic.

The reservoir fluid may be a fluid that is located in or is taken from a subterranean oilfield reservoir. The reservoir fluid may a fluid that is held naturally in the reservoir. This fluid may be petroleum, specifically crude oil, or may be formation water (interstitial water) or connate water.

In some embodiments, the fluid to be treated is a fluid that has been introduced by the reservoir operator into a subterranean location from the surface. These fluids are referred to herein as process fluids. A process fluid is any fluid that is introduced into a subterranean location by an operator for use in any of the exploration, appraisal, production, development and close phases of an oilfield or aquifer. Such fluids include drilling fluids, fracturing fluids and fluid loss control fluids, amongst others.

Thus a drilling fluid may be introduced into a wellbore and additionally may be introduced into a reservoir. The drilling fluid may then be treated to remove components that have been introduced into the mud downhole. Such treatment may be performed downwell, or at the surface, if the drilling fluid is returned to the surface.

The drilling fluid may be a drilling mud. The drilling mud may from part of a closed mud system where the mud is recycled back into wellbore after is has been returned to the surface and treated to remove solids.

The reservoir or process fluid may be gaseous or liquid or may comprise both phases. Preferably, the reservoir or process fluid is liquid. When the reservoir or process fluid is contacted with the sugar-based assembly, it is preferred that the reservoir fluid is in liquid form.

The reservoir fluid may be a fluid that has not otherwise been treated for the removal of components. Preferably this does not include the evolution of gas from the fluid

In an alternative aspect of the invention the sugar-based assemblies may be used to remove components from groundwater.

The composition of the reservoir fluid will depend on the nature of the'reservoir in which the fluid is located, or from which the fluid is taken. Likewise, the composition of the process fluid will depend upon the intended use of that fluid. The composition will also depend on whether the process fluid has been used or not. The composition will also depend upon the subterranean locations through which it has passed, and the material it has come into contact with e.g. the type of formation, the type of reservoir fluid or aqueous fluids.

In one embodiment, the reservoir fluid is the aqueous portion of fluid that is located in or taken from a subterranean reservoir.

The reservoir or process fluid may comprise a component to be removed as described herein. In some embodiments the reservoir or process fluid may not comprise the component. In this latter case, the sugar-based assembly may be provided as a precautionary measure, or may be part of a standard downhole tool.

The concentration of the component to be removed from a reservoir fluid will depend on the reservoir in which the fluid is derived, the formation through which the reservoir fluid passes, and the other fluids with which it comes into contact. The concentration of the components within the reservoir fluid may also change.

The concentration of the component to be removed from a process fluid will depend on the formation through which the process fluid passes, and the other fluids with which it comes into contact. The concentration of the components within the process fluid may also change.

Also provided by the present invention is a reservoir or process fluid obtainable or obtained by any of the methods described herein. The invention also provides a reservoir or process fluid comprising a sugar-based assembly of the invention.

### Wastewater

The present invention relates primarily to the treatment of reservoir or process fluids, particularly at a subterranean location. In other embodiments of the invention, the reservoir or process fluid may be treated at a surface location, although a subterranean location is most preferred.

In an alternative aspect of the invention, the sugar-based assembly may be used to remove a component from wastewater that has not been taken from a subterranean reservoir. Wastewater may be effluent from an industrial process performed at the surface. It may also include aqueous effluent from residential properties, e.g. sewerage. Wastewater may also be referred to as surface water.

Therefore, in one embodiment, the uses and methods of treating a reservoir or process fluid described herein may also be applied to wastewater, where appropriate.

Also provided by the present invention is a wastewater obtainable or obtained by any of the methods of delivering a component to a wastewater as described herein. The invention also provides a wastewater comprising a sugar-based assembly, of the invention.

### Additives

In some embodiments, the sugar-based assembly may be used, with one or more additives to bind a component to be removed from the reservoir or process fluid. Such additives, together with the sugar-based assembly, may form a complex with a component to be removed from the reservoir or process fluid.

The additive may have an amine group and/or a hydroxyl group. Some additives having an amine group include alkylamines, such as ethylenediamine. Preferably, the additive is selected from 1,3-diaminopropane (DAP), ethylenediamine (EN), and diethylenetriamine. Other additives include compounds having amine and hydroxyl groups. Examples include N,N-bis[(2-pyridylmethyl)-1,3-diaminopropan-2-ol] and 2-[(pyridin-2-yl)methylamino]ethanol.

The additive may be a solvent molecule. The solvent molecule may be water. In some embodiments, an additive may be a sugar as described herein. In other embodiments, the sugar-based assembly is used without additives.

Removal of a Component from a Reservoir or Process Fluid

In the present invention, the phrase “clean-up” is used to refer to a process whereby a fluid is treated such that the amount of a specified component in the fluid, taking into account any dilution or concentration effects, is reduced as a result of that treatment. The amount of component in a fluid may be expressed in moles, or by weight, or as a percentage change in those units.

The present invention provides the use of a sugar-based assembly for the removal of a component from a reservoir or process fluid. The sugar-based assembly is contacted with a reservoir or process fluid comprising the component, thereby to form a complex of the sugar-based assembly and the component. The resulting component-depleted reservoir or process fluid is then separated from the complex. The sugar-based assembly may be deployed to a subterranean location through which location a reservoir or process fluid will or does flow. The location may be referred to as a reservoir or process fluid flow path.

The sugar-based assembly and the complex may be insoluble or partially soluble in the reservoir or process fluid. The degree to which the sugar-based assembly or the complex is dissolved in the reservoir or process fluid may depend on the nature of the assembly, as well as the nature of the reservoir or process fluid and the particular conditions at the site of use. The reservoir or process fluid temperature may be altered or allowed to alter to change the amount of sugar-based assembly or complex that is dissolved in the reservoir or process fluid. Where such a change results in decreased solubility, this may be of assistance in the recovery of the complex or sugar-based assembly from the fluid, for example by filtration. Where such a change results in increased solubility, this may be of assistance in the interaction of the sugar-based assembly with the component in the fluid, thereby increasing the amount of complex formed.

The acidity or alkalinity of a reservoir or process may be altered to enhance complexation of the component to be removed, or to minimise complexation of other components in the fluid.

As used herein, the phrase “separated” includes methods where the reservoir or process fluid is permitted to move across and past the sugar-based assembly, for example flow based separation techniques.

The methods of the invention may be used to reduce the amount of a component in the reservoir or process fluid to a level acceptable for that fluid's subsequent use. The reduction in the amount of the component in the reservoir or process fluid may be necessary due to downstream processing considerations. The component may react with various processing apparatus or reagents, leading to reduced processing performance. The removal of the component at an early stage is therefore desirable. Furthermore, if the component can be retained in the reservoir, the need to treat or purify the reservoir or process fluid that is brought to the surface is minimised.

Alternatively, the maximum amount of a component in a fluid may be stipulated by a local authority, such as an environmental protection agency.

The sugar-based assembly may be regenerated by removal of the component from the complex, for example by ion exchange.

The component, either as part of the sugar-based assembly complex or as isolated from the complex as described below, may be further processed according to the local regulations regarding that ion's disposal.

The phrase “subterranean location” refers to a location that is subsurface. The subterranean location may be a reservoir or a wellbore. The reservoir may be a hydrocarbon reservoir or an aquifer. The location may also be a site in a wellbore (“downhole”).

Where a fluid is treated with the sugar-based assembly at a downhole location, the temperature of the fluid will be similar to that of the formation from which it is derived, or through which it passes. In some circumstances the temperature of the fluid may lie in the range from about 200° C. to about 260° C.

Where the formation of a complex is endothermic, the reservoir or process fluid may be used at elevated temperatures to increase complexation of the component with the sugar-based assembly.

The reservoir or process fluid is contacted with the sugar-based assembly when the temperature of the reservoir fluid is below that of the decomposition temperature of the sugar.

The reservoir or process fluid may be contacted with the sugar-based assembly in line with other treatment processes (i.e. sequential treatment of the fluid) or in combination with other treatment processes (i.e. simultaneous treatment of the fluid). This may improve mixture purification times, and hence increase throughput.

A reservoir or process fluid may be contacted with several different sugar-based assemblies, either simultaneously or sequentially. Each sugar-based assembly may be selective for a different particular component.

A reservoir or process fluid that is taken from a subterranean location may be additionally treated to remove other matter such that the treated fluid may be safely disposed of, e.g. into a sewer system, or recycled, e.g. for use in mud drilling fluid and returned to the downhole location. The matter to be removed from the reservoir or process fluid, and particularly a mud, may be particulate matter such as clay particles. As part of a wastewater cleanup and clarification process, aggregation techniques may be used to remove the particulate matter. Changes in fluid pH, the addition of alum or high molecular weight polymers may be considered. The particulate matter may be filtered or centrifuged to strip out the solids.

The present invention also provides the use of a sugar-based assembly in a method for maintaining the purity of a fluid. A fluid may be obtained by purification of a fluid, which fluid is then collected in a reservoir, preferably a subterranean reservoir. The reservoir fluid may then be extracted from the reservoir for use at a later date. During storage in the reservoir it may be necessary to maintain the purity of that fluid in the reservoir or minimise the degree of contamination of the fluid. The sugar-based assembly of the invention may be deployed in the reservoir for this purpose.

Such processes are particularly advantageous as they avoid the need to construct or operate expensive desalination plants during periods of peak demand.

In one preferred embodiment, the fluid is desalinated water. This water may be injected into an aquifer when demand for water is low, for example during the winter months, and then retrieved when demand for water is high, for example during the summer months. A sugar-based assembly may be used to, prevent or minimise contaminants leaching into the fluid, or to remove those contaminants that have leached into the fluid.

Thus, the invention provides a method of maintaining the purity or minimising the contamination of a fluid within a reservoir.

The sugar-based assembly and component may remain downhole after the reservoir or process fluid is retrieved, or it may be brought to the surface with the fluid and separated there. It is preferred that harmful or potentially harmful components are retained in the subterranean environment as this would avoid the need for further processing steps were the components to be taken to the surface where they would require disposal according to the local environmental regulations. Such retention is particularly preferred where the components are Pb or Hg ions.

The sugar-based assembly may be retained downhole as a complex with a component. The sugar-based assembly may have a formation support, which ensures that the complex remains downhole. Alternatively, the sugar-based assembly may have a support that is not formation. In this embodiment, the sugar-based assembly may nevertheless be attached to a formation surface in order to retain a complex of the assembly and the component downhole. The sugar-based assembly may also be a component of a proppant and be retained in a formation fracture as described below. Alternatively, a complex may be retained downhole using appropriate well-sealing techniques as are known in the art.

The sugar-based assemblies of the present invention may be used as a constituent of a fracturing fluid, water loss control fluid, drilling fluid, or in a placement fluid for the selective placement of the sugar-based assembly itself.

The present invention provides a method of treating a subterranean formation of a hydrocarbon well comprising the steps of providing a sugar-based assembly according to the present invention and delivering the sugar-based assembly into the well.

In one embodiment, the sugar-based assembly may be provided in a fluid, such as one of the fluids described above. The sugar-based assembly is typically suspended in the fluid. The sugar-based assembly may therefore be delivered into the well by injection.

Alternatively, a downhole tool comprising the sugar-based assembly of the invention may be provided as described below. This tool may be delivered into the well.

The present invention also provides a reservoir or process fluid that is depleted of a component by a method as described herein.

### Corrosion

The sugar-based assemblies described herein may be used to minimise the corrosion of the equipment used in the drilling, extraction, recovery and processing of reservoir fluids. By binding a corrosion-causing component in the reservoir or process fluid. Particularly, the sugar-based assemblies may be used to limit or prevent the corrosion of those equipment parts that come into frequent or constant contact with the reservoir or process fluid. These parts may be located downhole in use. However, the sugar-based assemblies may also be used to limit or prevent corrosion of surface equipment such as surface lines.

### Scale

The sugar-based assemblies described herein may be used to minimise the formation of scale on the surface of equipment used in the drilling, extraction, recovery and processing of reservoir fluids. The surface may be a subterranean surface, notably the surface of a downhole tool or the lining (casing) of a wellbore.

Scale generally refers to a deposit on a surface across which a reservoir or process fluid passes. The surface may be the casing of a wellbore, the surface of a pipeline or a downhole tool. The build up of such deposits can affect the recovery of reservoir or process fluids. Where the deposits line a fluid conduit, the deposit can limit the flow of fluid through that conduit by restricting the flow path. Furthermore, where a section of a deposit is released from the surface, it may be carried as an insoluble lump in the fluid through the reservoir or process fluid processing facilities where it has the potential to damage downstream equipment.

Scale deposits may also limit the heat transfer capacity of heating elements or heat exchangers where such deposits coat the contact surfaces.

Deposits may also form on tools located and operating downhole. Any scale coating on a mechanically operating surface has the potential to impact on the smooth functioning of that mechanical operation.

Particular types of scale may precipitate during alkaline flooding and steam flooding well operations. These scales include calcium carbonate, magnesium silicate and amorphous silica. During carbon dioxide flooding operations, various scales may be precipitated. Under acidic conditions scales such as barium sulfate may form. Iron carbonate may also form from the combination of carbon dioxide with corrosion-produced iron.

There is a need therefore for methods to reduce the amount and extent of scale deposits on reservoir or process fluid contact surfaces.

The sugar-based assembly of the invention may be used to sequester a component that is associated with the formation of scale, and thereby reduce the extent of scale formation. The component which is sequestered may be iron or the cation of an alkaline earth metal salt.

### Wastewater Clean Up

The sugar-based assemblies described herein may be used to remove components from wastewater where those components may cause damage to the natural environment, or may cause damage to processing facilities at a well bore or well head, or to water processing facilities. Where these components are ions, they may be referred to as wastewater ion contaminants. They may be ions which have entered the water naturally or they may be present as a result of natural processes e.g. contaminants from practices no longer considered acceptable.

Treatment of wastewater with a sugar based assembly of this invention may be performed to remove a contaminant known to be present, or as a precaution against possible contamination.

Recovery of Components from a Reservoir or Process Fluid

The components bound to the sugar-based assembly, i.e. in complex, may be recovered for further treatment or utilisation.

Techniques for the release of the components from the complex may include treatment of the complex with an eluant. The eluant is intended to disrupt the interaction between the support-bound sugar and the component. An “elution buffer” may be used to elute the component from the assembly. The conductivity and/or pH of the elution buffer is/are such that the component is eluted from the support.

Elution buffers are commonly used in affinity ligand chemistry, and suitable elutants for use in the present invention may be readily determined by one of skill in the art.

For example, lead absorbed on alginic acid sugars may be desorbed using nitrilotriaceticacid.

Such techniques may also be used to regenerate the sugar-based assembly for further use in the methods described herein, thereby providing further potential cost savings to the separation process.

The released component may be isolated for disposal or further treatment, as appropriate.

### Downhole Tool

The present invention also provides a downhole tool for use in the removal of a component from a downhole reservoir or process fluid, wherein the tool comprises a sugar-based assembly as described above.

Also provided is the use of a downhole tool in a method of removing a component from a downhole reservoir or process fluid. The method may comprise the step of providing a downhole tool at a downhole location. The method may comprise the step of making the sugar-based assembly of the downhole tool available for contact with the downhole reservoir or process fluid.

The downhole tool may be retrievable from the downhole location.

In one embodiment, the sugar-based assembly is releasable from the downhole tool. Thus a sugar-based assembly may be delivered to a specific downhole location by appropriate placement and manipulation of the downhole tool. The use of the tool in this way is an alternative to the use of a fluid, such as a drilling mud or fracturing fluid, to deliver the sugar-based assembly to locations within a reservoir.

In one method of the invention, the downhole tool is brought to the surface after the sugar-based assembly of the downhole tool has been released from the tool.

Alternatively, the sugar-based assembly may be retained on the downhole tool. When the tool is returned to the surface the sugar-based assembly may be analysed to determine whether certain components are present at the downhole location. The sugar-based assembly may be analysed directly, or may be treated with an eluant to release any complexed component from the sugar complex. The eluted mixture may then be analysed for the presence of various components.

The downhole tool is a device suitable for deployment in a well bore. The tool is configured to be operable downhole. The tool may be operable from the surface. Alternatively, the downhole tool may be independent of the surface when downhole. For example, the tool may be pre-programmed to operate downhole.

A downhole tool according to the present invention may be attachable to a wire line, or to coiled tubing or to a drill string and be operable when so attached.

A downhole tool may be a tool for use in delivering analytical equipment to the bottom hole. This equipment may comprise seismological monitoring equipment. Alternatively the analytical tool may be a sensor for the analysis of the reservoir or process fluid. The sensor may be suitable for providing data relating to the density, viscosity, temperature, pH, and composition, amongst others, of the reservoir or process fluid.

In one embodiment, the downhole tool is provided with analytical equipment suitable for the evaluation of the component held in complex with the sugar-based assembly. Thus, the component can be identified and quantified in situ without the need to bring the tool to the surface for analysis. Such a system may be used to provide real time data concerning the composition of a fluid at a downhole location. The applicant's copending application describes a sugar-based assembly for use in the detection and quantification of components in a reservoir or process fluid. This assembly may be used in combination with the sugar-based assembly of the invention.

The downhole tool may be disposable. Thus, the tool may be deployed to the preferred downhole location where the sugar-based assembly is made available for contact with the reservoir or process fluid and the downhole tool be left at that location. This may be appropriate where it is not feasible to return the tool to the surface. For example, it may not be economically viable to return the tool to the surface, or the tool may be lodged in the well, deliberately or otherwise, such that it may not be moved or moved only through highly complex or expensive extraction techniques.

### Filter

The present invention also provides a filter for use in the removal of a component from a reservoir or process fluid, wherein the filter comprises a sugar-based assembly as described above.

The filter may be a column into which is packed the sugar-based assembly. Alternatively, the filter may be a column which is lined on its surface with sugar-based assembly and across which the fluid is passed. The filter may also be a bed comprising a sugar-based assembly through which the fluid passes.

The sugar-based assembly may be attached by the support to a surface of the filter. Alternatively, the support of the sugar-based assembly may form part of a surface of the filter.

The filter may be used in flow methods. The rate of fluid flow through or across the filter depends on the composition of the filter. Preferably the filter is configured for deployment and operation in well bore or reservoir. The filter may be configured to operate at high flow throughput.

The density of the sugar-based assembly on the filter may be selected to optimise the complexation of a component from a reservoir or process fluid.

The filter may be located downhole, for example incorporated into part of the casing of a wellbore.

In one embodiment, the filter comprises a formation surface to which is attached a sugar-based assembly of the present invention. Preferably, the formation surface is a surface on a reservoir or process fluid flow path. Where the filter is retained downhole, the component that is complexed by the sugar-based assembly is retained downhole also. As explained herein, this is particularly advantageous, because something which is never taken to the surface does not become a disposal problem at the surface.

A filter of the invention may comprise one or more different sugar-based assemblies of the invention. Each sugar-based assembly may be suitable for complexing a different component from the reservoir or process fluid. The sugar-based assemblies may be disposed along the filter in a sequence, randomly, or in blocks. Alternatively the sugar-based assemblies may be arranged such that they are disposed across the fluid flow path.

Alternatively filters each having a different sugar-based assembly may be disposed along a fluid flow path.

The invention therefore provides a method of recovering a component from a subterranean reservoir or process fluid, the method comprising the step of contacting a subterranean reservoir or process fluid comprising the component with a filter of the invention, wherein the filter comprises a sugar-based assembly of the invention, thereby to form a complex of the component with the sugar-based assembly, and a reservoir or process fluid which is depleted of the component.

The invention also provides a method of preparing such a filter, comprising the step of deploying a sugar-based assembly to a downhole location in a reservoir or process flow path and attaching the sugar-based assembly to a formation surface on the reservoir or process fluid flow path, thereby to form a filter of the invention.

Preferably the method comprises the step of separating the depleted reservoir or process fluid from the filter.

### Fracturing Fluid

The present invention also provides a fracturing fluid for use in the mechanical (i.e. hydraulic) fracturing treatment of a reservoir, wherein the fracturing fluid comprises a sugar-based assembly as described herein. The fracturing fluid may comprise a proppant, and the sugar-based assembly may be a component of the proppant. The invention accordingly provides a proppant having a sugar-based assembly of the invention. The reservoir is preferably a petroleum reservoir.

The proppant may be ceramic, a low density proppant, re-sieved sand, resin-coated ceramic, resin-coated sand, sand, or sintered bauxite.

The invention also provides a method of fracturing a reservoir formation. The method comprises the step of introducing a fracturing fluid of the invention into a reservoir formation under hydraulic pressure thereby to fracture the formation (and so increase flow paths in the formation for the extraction of fluids from the reservoir).

The fracturing fluid is permitted to enter the fracture thereby to provide proppant in the fracture. The proppant is retained in the fracture once the hydraulic pressure is removed and so prevents complete closure of the fracture.

The invention provides a method of removing a component from a reservoir or process fluid comprising the steps of delivering a proppant into a reservoir fracture thereby to provide a sugar-based assembly of the proppant in a reservoir or process fluid flow path, and contacting the sugar-based assembly of the proppant with a reservoir or process fluid, thereby to from a complex of the sugar-based assembly of the filter and the component. The reservoir or process fluid is consequently depleted of the component.

Preferably the method comprises the step of separating the depleted reservoir or process fluid from the proppant.

In one embodiment, the sugar-based assembly is a component of the proppant. In use, the assembly is therefore retained in the fracture once the hydraulic pressure is removed. Fluid that passes through the fracture preferably contacts the sugar-based assembly. The sugar-based assembly may from complexes with components in the reservoir or process fluid. The components will be retained in the fracture, and will not be taken out of the reservoir and to the surface. This is particularly advantageous where the component is harmful or potentially harmful, as the component will not be taken in the fluid to the surface, where the fluid would have to be treated according to local regulations concerning the component.

In some embodiments, the sugar-based assembly may comprise a support that is a component of the proppant. In other embodiments, the sugar-based assembly may comprise a support that is attached to the main proppant material.

Other components of the proppant may include sand, resin-coated sand, and high strength ceramic materials such as sintered bauxite.

In other embodiments, the sugar-based assembly is not a component of the proppant. Thus the sugar-based assembly is not retained in a reservoir fracture once the hydraulic pressure is removed. The sugar-based assembly may be used to remove components that are introduced into the fracturing fluid during the fracturing process. When the fracturing fluid is returned to the surface, the sugar-based assembly may be separated from the remainder of the fluid for recovery or treatment of the complexed components.

Fracturing fluids may be based on polymers or viscoelastic surfactants. Preferred components of the fracturing fluid include a proppant, one or more thickeners, salts and dispersion fluids. Such components, and others, are well known in the art. Crosslinking agents may also be added to polymer-containing fracturing fluids to increase the viscosity of the fluid. Preferred crosslinkers include borate, titanium chelates and zirconium chelates.

### Preferred Sugar-Based Assemblies

Various embodiments of the invention are described in more detail below.

### Monosaccharides

A preferred monosaccharide sugar for use in the sugar-based assembly of the invention may be independently selected from any one of the examples given below.

In one embodiment, the monosaccharide may be glucosamine. It has been reported that such groups are capable of complexing a number of metal ions, including Cu, Pb and Zn ions, amongst others.

Other glucosamine-based saccharides for use in the present invention include N-acetylglucosamine, 2-amino-2-deoxy-D-glucopyranose (GlcNH₂), 2-amino-2-deoxy-D-galactopyranose (GalNH₂) and 2-amino-2-deoxy-D-mannopyranose

An additive such as 1,3-diaminopropane (DAP), ethylenediamine (EN), or diethylenetriamine may be used with a glucosamine-based monosaccharide to complex a component, such as a metal ion.

In other embodiments, the monosaccharide may be an N-glycoside. In certain embodiments the monosaccharide may be an N-glycoside of an amino monosaccahride, such as glucosamine, galactosamine, or mannosmaine. The glycoside preferably comprises one or more amino groups. In one embodiment, the glycoside is derived from an alkyl amine, such as diethylenetriamine and ethylenediamine. S- and O-glycoside monosaccharides may also find use in the present invention.

Oxidised and reduced monosaccharides such as gluconic acid and glucaric acid may find use in the present invention.

### Disaccharides

Disaccharide sugars for use in the present invention include sucrose, lactose, maltose, trehalose, cellobiose, and variants and derivatives thereof.

A disaccharide for use in the present invention may contain one or two of the preferred monosaccharide groups described above. The disaccharide lactobionic acid may be used as a sugar in the present invention.

### Oligosaccharides

Oligosaccharide sugars for use in the present invention include cyclodextrin. The cycicodextrin may be α-, β-, or γ-cyclodextrin.

An oligosaccharide as described herein refers to a sugar having from 3 to 10 saccharide units.

### Polysaccharides

Polysaccharide sugars are widely available and may be isolated from many natural sources. They may therefore be considered as environmentally benign. A sugar-based assembly may be made from one or more polysaccharides, notably such polysaccharides as alginates, pectins and pectates, chitins, guar, chitosans, cellulose, amylose, and amylopectin. Particularly preferred polysaccharides include alginates and guar. The most preferred polysaccharides are alginates.

Polysaccharides have complex structures, and polysaccharides derived from different natural sources typically have different structures. The difference in structure may relate to slight differences in average molecular weight or degree of substitution, where appropriate. Also, polysaccharides in a family may differ in their repeat structure; with some polysaccharides having a predominantly block structure or repeat structure, or mixtures of both. Generally, though, a polysaccharide for use in this invention has 11 or more saccharide units in the molecule. The polysaccharide may average 50 or more, 100 or more, 500 or more, or 1,000 or more saccharide units.

A polysaccharide may be crosslinked to improve the mechanical stability of beads or other particles. For example, glutaraldehyde, ethyleneglycol diglycidyl ether (EGDGE), epichlorohydrin or N-(3-dimethylaminopropyl)-N′-ethylcarbodiimide hydrochloride (carbodiimide) may he used.

In other embodiments, the polysaccharide may comprise a saccharide unit that is obtainable from a ring saccharide unit as described herein that is treated with an oxidant, thereby to open the ring. Typically, the oxidant is a periodate. Preferably the oxidised product is reacted with a reagent to form a substituted ring-opened product. Where the intermediate is a di-aldehyde, the intermediate may be treated with an amine to form a Schiff base product. This product may then be reduced to provide an amine-containing ring-opened unit within the polysaccharide.

### Alginates and Pectins

Alginate and pectin polysaccharides find use in the sugar-based assemblies of the present invention.

Alginates comprise linear unbranched polymers containing β-(1→4)-linked D-mannuronic acid and α-(1→4)-linked L-guluronic acid residues. These residues may be arranged as blocks of similar and strictly alternating residues.

The majority of the structure of pectin consists of homopolymeric partially methylated poly-α-(1→4)-D-galacturonic acid residues.

The general structure of alginate is shown below with a repeat sequence of a pair of L-guluronic acid saccharide units and a pair of D-mannuronic acid saccharide units:

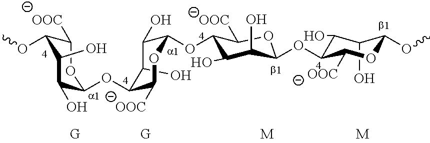

Alginate and pectin polysaccharides comprise carboxylic acid groups. The carboxylic acid groups may act as ligands to form complexes with components such as metal ions. Indeed, it has been reported that copper and cobalt ions may be recovered from an acidic cobalt ore leachate using an alginate gel [Jang et al.]. It has also been reported that alginates have a high complexation ability for lead [Deans et al.]. Thus, such polysaccharides are of use in the sugar-based assemblies described herein for the removal of a component from a reservoir or process fluid.

Owing to the non-toxic nature, alginate and pectin polysaccharides are particularly useful in the methods described herein, especially where the reservoir fluid is an aquifer fluid.

Some of the carboxylic acid groups may be replaced by ester, typically alkyl esters such as methyl ester.

In a preferred embodiment of the invention a sugar-based assembly is alginate-based and may be an alginate-based particle.

One embodiment of the invention uses a derivative of alginate with an increased amount of carboxylic acid moieties compared to natural alginate. Natural alginate typically comprises one carboxylic acid moiety per saccharide unit (as seen in the representative structure above) but the amount of carboxylic acid moieties may be increased by derivatising saccharide units in an alginate with a group containing a carboxylic acid. It is preferred that the saccharide unit is derivatised at one or two hydroxyl groups of the saccharide unit, by attaching the residue of a dicarboxylic acid such as tartaric or maleic acids. The derivative may comprise, on average, 1.25 or more, 1.5 or more, 1.75 or more, or 2 or more, 2.5 or more, or 3 carboxylic acid moieties per saccharide unit.

The inventors have found that the absorption capacity of a sugar-based assembly for a metal ion may be increased by increasing the amount of carboxylic acid moieties in the sugar. In particular, the inventors have found that increasing the amount of carboxylic acid moieties in an alginate sugar increases the absorption capacity of an alginate-based assembly for lead ions.

### Chitin and Chitosan

Chitin is a polysaccharide comprising N-acetylglucosamine. Chitsoan is an aminopolysaccahride that is typically produced by alkaline deacetylation of chitin. The amine group on chitosan may be derivatised to improve selectivity or binding capacity of the polysaccharide for a particular component or mixture of components. Alternatively or additionally, the saccharide units within chitin and chitosan polysaccharides may be derivatised at the 6-hydroxyl group. Derivatives with such substituents may also have improved selectivity and binding capacity for a particular component.

### Cellulose

Cellulose is a linear polysaccharide composed of several thousand of β-(1→4)-D-glucopyranose units in ⁴C₁ conformation. One or more glucopyranose units may be replaced with a variant or derivative of the glucopyranose. Methyl cellulose, where up to 30% of the hydroxyl groups are methylated, may be used. Hydroxypropylmethylcellulose (HPMC) and carboxymethylcellulose (CMC) also find use in the present invention. The degree of substitution in the cellulose may be selected based on the performance of the cellulose as a ligand to complex components in a reservoir or process fluid. Alternatively, the level of substitution may owe to the availability of that sugar from commercial sources.

### Guar

Guar may also be used as a sugar in the assemblies of the present invention. Guar comprises a backbone of mannose having side groups of galactose. Either of these units may be substituted. The 6-hydroxyl group of the galactose unit is the most preferred point of substitution.

### Example 1

This example demonstrated the ability of sodium alginate beads to remove lead from aqueous solution. In this demonstration the beads constituted a sugar-based assembly which was not immobilized onto a support.

Sodium alginate (4 g, 20.2 mmol) was dissolved in deionized water (100 mL) by mechanical stirring at room temperature for 45 min. This solution was then added dropwise at room temperature to a solution of CaCl₂ (in an amount equivalent to the COOH groups of the sodium alginate) in deionized water (50 mL). The CaCl₂ functioned as a bead generator. Beads of sodium alginate were precipitated as addition took place. The precipitated beads were then washed with deionized water for 30 min (3×100 mL) with slow stirring. A similar preparation was also carried out using as bead generator a mixture of B(OH)₃ and CaCl₂ in amounts which were respectively 67% and 50% of the amounts equivalent to the COOH groups of the sodium alginate.

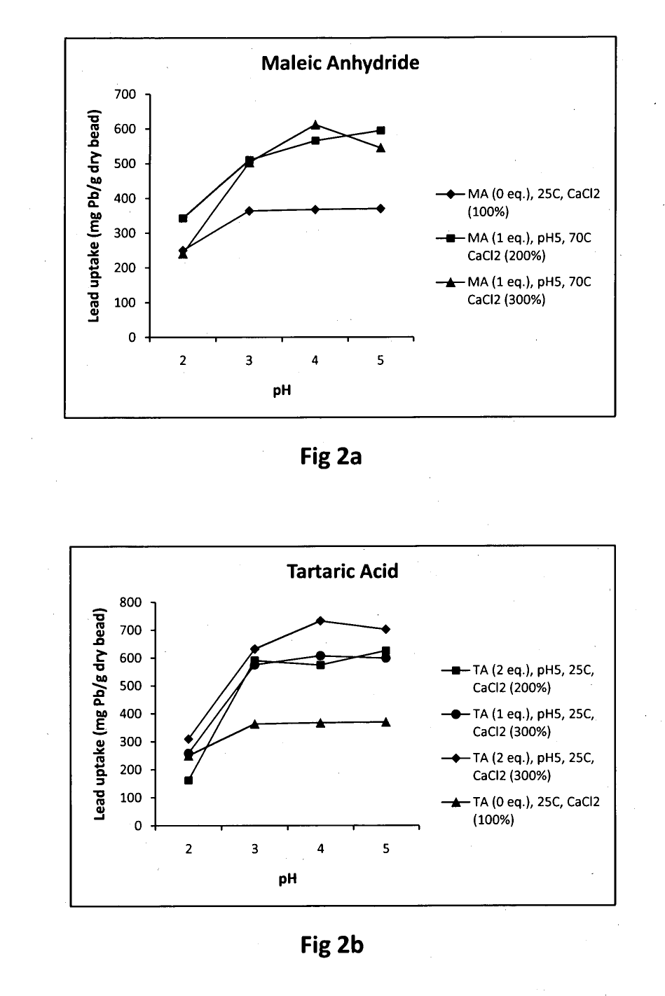

To demonstrate lead absorption, a small quantity of lyophilized beads was weighed and placed in a solution of known pH. A solution of Pb(NO₃)₂ at a known concentration was added. After 24 hours at room temperature, the beads were removed by filtration and the lead content of the filtrate was determined. The amount of lead in the beads was then calculated. It was found that at pH2 the amount of lead taken up was 250 mg per gram dry beads while at pH 3, 4 or 5 the amount taken up was about 350 mg per gram dry beads, as shown graphically in FIG. 2a.

Some variations in the bead preparation procedure were investigated. The swellability, i.e. the amount of water taken up by dry beads when placed in deionized water, was determined as was the lead uptake.

Increasing the preparation temperature to 70° C. led to a reduction in water uptake (also referred to as hydration index) to about 60% of that observed when the preparation temperature was 25° C. Whilst it may be envisaged that the particle formation reaction may be carried out at raised temperatures such as at least 35° C. or at least 45° C., it is likely to be beneficial to carry it out at temperatures not exceeding 45° C., better not exceeding 35° C.

Reducing the amount of CaCl₂ bead generator from the equivalent amount to 50% of the equivalent amount increased the hydration index by a factor of three but weakened the beads.

The alginate may be cross-linked using a cross-linker. This is best done by addition of the cross-linker to the alginate prior to particle formation which ensures that the internal part of the bead is cross-linked. Beads prepared in this manner were found to be resistant to degradation at basic pH (pH 13), in the presence of sodium carbonate, and at acid pH (from pH 2.0 to 5.0). However, even at high reaction temperatures and using a large excess of cross-linker, it was found necessary to add a bead generator to avoid the formation of fragile beads. Possible cross-linkers include ethyleneglycol diglycidyl ether (EGDGE), epichlorohydrin and N-(3-dimethylaminopropyl)-N′-ethylcarbodiimide hydrochloride (carbodiimide). When these were used there was a reduction in hydration index, EGDGE leading to a hydration index which was half that observed with carbodiimide. Epichlorohydrin led to a hydration index which was intermediate between the values observed with carbodiimide and EGDGE.

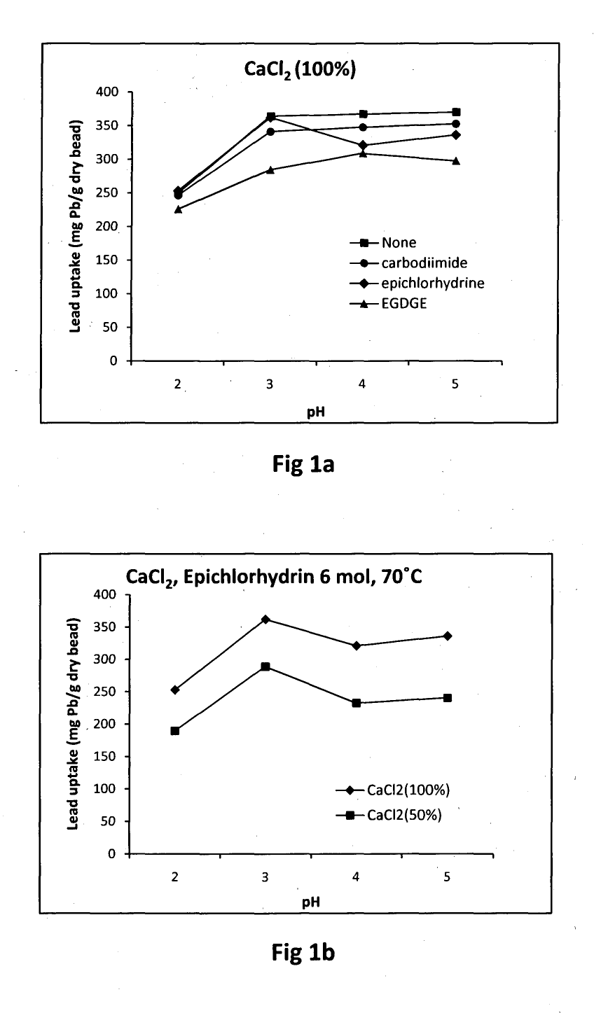

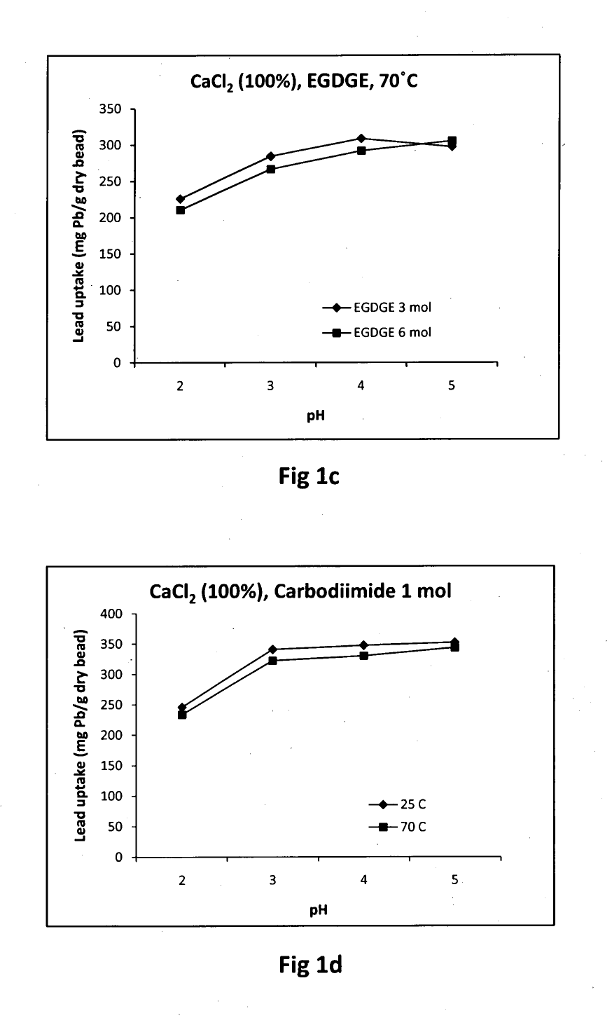

It was also observed that use of a cross linker led to some reduction in lead uptake, as shown by FIG. 1a, with the largest influence, and hence the smallest lead uptake, being associated with EGDGE the least hydrophilic cross-linker. However, in the experiments carried out, when cross linker was included the cross-linker concentration and the temperature at which the beads were formed did not appear to make much difference to the metal uptake (see FIGS. 1c and 1d) while reducing the amount of CaCl₂ bead generator also reduced the lead uptake (FIG. 1b).

### Example 2

Sodium alginate was reacted with maleic anhydride or L-tartaric acid to increase the amount of carboxylic acid moieties in the alginate polymer backbone. The general reaction schemes, and possible products, are shown below:

Maleic anhydride derivatisation

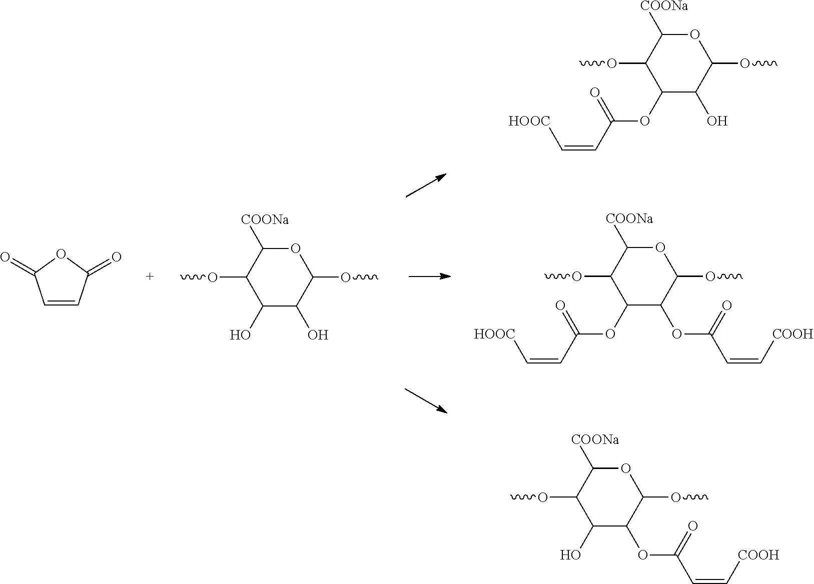

Tartaric acid derivatisation

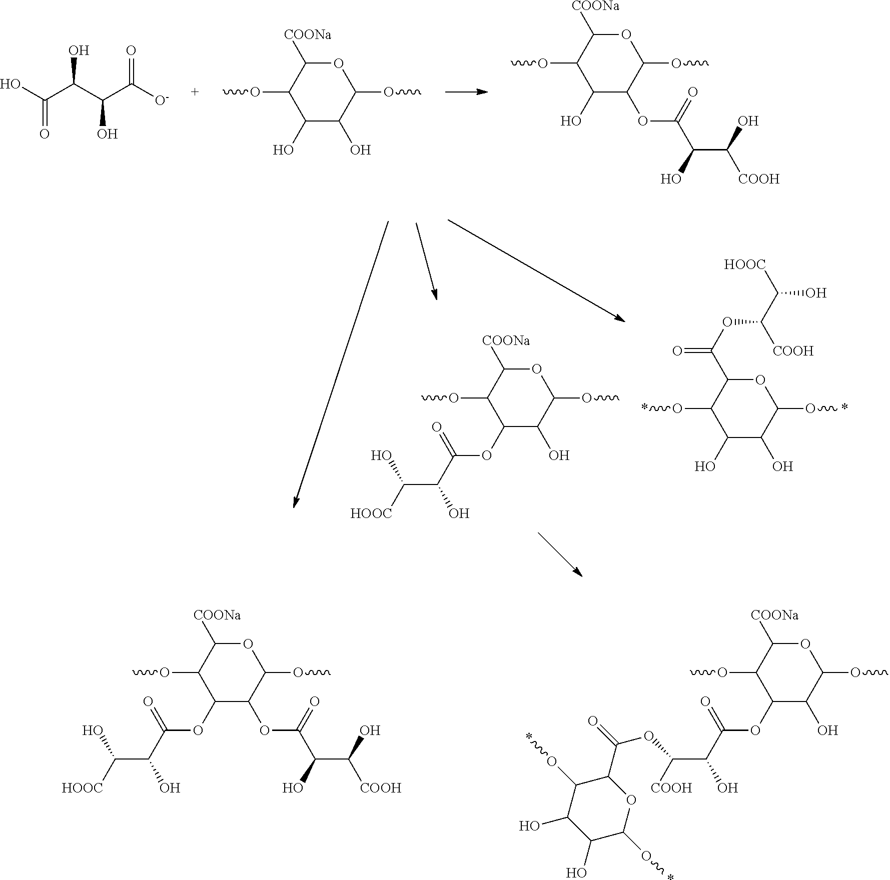

In both reaction schemes, the effect is to esterify a hydroxyl group of a saccharide ring in the alginate chain with one carboxyl function of maleic or tartaric acid so that the other carboxyl function of that acid provides a carboxylic acid group attached to the alginate chain.

Reaction was carried out using tartaric acid or maleic anhydride in a quantity sufficient to esterify one hydroxyl group of each sugar ring (i.e. equivalent to one hydroxyl group) or with double that quantity (equivalent to two hydroxyl groups of each sugar ring). Beads were prepared using calcium chloride as a bead generator, as in the previous example, but it was found to be necessary to increase the amount of Ca²⁺ (which was consistent with the higher carboxylic acid ratio in the derivatised alginate). Typically the amount of calcium chloride necessary to form stable beads was from 200 to 300% of the amount equivalent to the COOH groups of the original sodium alginate.

When maleic anhydride was used, beads were best formed at 70° C. When tartaric acid was used, beads were formed at room temperature. Some experiments were carried out using both tartaric acid to introduce carboxyl groups and carbodiimide to form cross links. All these beads made with derivatised alginate were found to be stable under every degradation test, even when no cross-linker was used in the synthesis.

Lead uptake was examined as in the previous example. FIG. 2a shows lead uptake results for beads made with one equivalent of maleic anhydride, using two concentrations of bead generating calcium chloride. Results for beads made from unaltered alginate are included for comparison, and it can be seen that derivitisation with maleic anhydride increased the lead uptake substantially. FIG. 2b shows results with one and two equivalents of tartaric acid and again the results for unaltered alginate are included for comparison. Here too, derivitisation increased the lead uptake.

The preferred embodiments of the invention are combinable in any combination, where appropriate, unless otherwise stated.

### REFERENCES

The following references are incorporated by reference herein in their entirety.
B. Bidstein, M. Malaun, H. Kopacka, K.-H. Ongania, K. Wurst, J. Organometallic Chem., 552 (1998) 45.
J. C. Cowan, D. J. Weintritt. 1976. Water-formed Scale Deposits. Gulf Publishing Co. Houston Tex.
J. R. Deans, B. G. Dixon; Water Res. 26, 469, (1992)
H. Eckert, C. Seidel, Angew. Chem. Int. Ed. Engl., 25 (1986) 159.
H. Eckert, B. Forster, C. Seidel, Chem. Sci., 46 (1991) 339.
T. W. Green and P. G. M. Wuts, Protective Groups in Organic Chemistry, 3rd Edition, John Wiley & Sons, Inc., New York, 1999.
Jang, L. K., Lopez, S. L., Eastman, S. L., Pryfolge, P.; Biotechnol. Bioeng., 37, 266, (1991)
B. A. Keay, R. Rodrigo, J. Am. Chem. Soc., 104, (1982) 4725.
A. S. Kende, D. P. Curran, J. Am. Chem. Soc., 101 (1979) 1857.
L. Xiao, R. Kitzler, W. Weissensteiner, J. Org. Chem., 66 (2001) 8912.
F. W. Ziegler, K. W. Fowler, S. Kanfer, J. Am. Chem. Soc., 98 (1976) 8282.

1. A method of removing a component from a reservoir or process fluid comprising a step of contacting the fluid with a sugar-based assembly comprising a sugar which is immobilized in a solid form insoluble in the fluid, whereby to form a complex of the component with the sugar-based assembly and reservoir or process fluid which is depleted of the component.

2. The method of claim 1, wherein the sugar-based assembly is a particle.

3. The method of claim 2, wherein the sugar is a polysaccharide is an alginate.

4. The method of claim 3, wherein the polysaccharide is an alginate.

5. The method of claim 3, wherein the polysaccharide incorporates modifications to the functional groups present on the polysaccharide chain.

6. The method of claim 5, wherein he polysaccharide is an alginate modified by addition of residues of a dicarboxylic acid.

7. The method of claim 3, wherein the polysaccharide is crosslinked.

8. The method of claim 1, wherein the sugar-based assembly comprises a sugar immobilized onto a support which is insoluble in the fluid.

9. The method of claim 8, wherein the sugar is chemically bound to the support either directly or via a linker group.

10. The method of claim 8, wherein the support is a proppant.

11. The method of claim 8, wherein the support is a surface of a subterranean formation.

12. The method of claim 1, wherein the component which is removed is a scaling ion.

13. The method of claim 1, wherein the component is an ion selected from the ions of B, Cu, Fe, Co, Ni, Ba, Ca, Sr, Mo, W, Zn, Cd, Hg, Pb, Pd, Pt, and V.

14. The method of claim 1, wherein the component is a Pb ion.

15. The method of claim 1, wherein the fluid originates from a subterranean formation and the step of contacting the fluid with the sugar-based assembly takes place at a subterranean location.

16. The method of claim 15, wherein the subterranean location is an aquifer, a petroleum reservoir, or a wellbore which penetrates an aquifer or petroleum reservoir.

17. The method of claim 15 additionally comprising the preliminary step of deploying a sugar-based assembly to a subterranean location.

18. The method of claim 1, wherein an additive is provided at the contacting step.

19. The method of claim 1 further comprising the step of separating the complex from the depleted reservoir or process fluid.

20. The method of claim 1 further comprising a step of releasing the component from the complex.

21. A method of removing a component from a reservoir or process fluid comprising a step of contacting the fluid with a filter which comprises a sugar-based assembly comprising a sugar which is immobilized in a solid form insoluble in the fluid, thereby to form a complex of the component with the sugar-based assembly of the filter and a reservoir or process fluid which is depleted of the component.

22. The method of claim 21 further comprising a step of separating the reservoir or process fluid depleted of the component from the filter.

23. A filter having a sugar-based assembly as defined in claim 1.

24. Use of a filter according to claim 23 in a method of removing a component from a reservoir or process fluid.

25. A downhole tool configured for deployment downhole, the downhole tool comprising a sugar-based assembly as defined in claim 1.

26. A downhole tool according to claim 25, wherein he downhole tool is attachable to a drill string.

27. A downhole tool according to claim 25, wherein the sugar-based assembly is releasable from the downhole tool.

28. A method of recovering a component from a reservoir or process fluid comprising the steps of (i) deploying the downhole tool of claim 25 to a downhole location; (ii) contacting the sugar-based assembly of the downhole tool with a reservoir or process fluid comprising a component, thereby to from a complex of the sugar-based assembly of the filter and the component, and a reservoir or process fluid which is depleted of the component.

29. The method of claim 28 further comprising the step of (iii) removing the downhole tool from the downhole location to a surface location.

30. The method of claim 28, wherein the sugar-based assembly of the downhole tool is released from the downhole tool into the reservoir or process fluid.

31. A fracturing fluid having a sugar-based assembly as defined in claim 1.

32. The fracturing fluid according to claim 31, wherein he sugar-based assembly comprises part of a fracturing fluid proppant.

33. A proppant bearing a sugar-based assembly as defined in claim 1.

34. Use of a fracturing fluid according to claim 31 in the hydraulic fracturing treatment of a reservoir.

35. A method of removing a component from a subterranean reservoir or process fluid comprising the steps of (iii) delivering a proppant according to claim 33 to a reservoir fracture thereby to provide a sugar-based assembly of the proppant at a reservoir or process fluid flow path; and (iv) contacting the sugar-based assembly of the proppant with a reservoir or process fluid, thereby to form a complex of the sugar-based assembly of the proppant and the component, and a reservoir or process fluid which is depleted of the component.

36. The method of claim 35, comprising the preliminary steps of (i) providing a fracturing fluid at a reservoir formation; and (ii) fracturing the reservoir formation.

37. The method of claim 35, wherein the reservoir formation is fractured in a hydraulic fracturing treatment.

38. A sugar-based assembly for recovering a component from a reservoir or process fluid, wherein the sugar-based assembly is as defined in claim 1.
